(19) United States
(12) Patent Application Publication
(10) Pub. No.: US 2026/0162887 A1
(43) Pub. Date: Jun. 11, 2026

(54) CORE MANUFACTURING METHOD, DEVICE, AND LAMINATED IRON CORE

(71) Applicant: NHK SPRING CO., LTD., Yokohama-shi, Kanagawa (JP)

(72) Inventors: Kosuke TAMARU, Yokohama-shi, Kanagawa (JP); Takeshi HAGIWARA, Yokohama-shi, Kanagawa (JP)

(21) Appl. No.: 18/706,535

(22) PCT Filed: Dec. 2, 2022
(86) PCT No.: PCT/JP2022/044636

§ 371 Date: May 1, 2024

(30) Foreign Application Priority Data
Dec. 6, 2021 (JP) 2021-198146

(51) Int. Cl. H01F 41/02; H01F 27/24; H02K 15/027; H02K 15/0273

(52) U.S. Cl. CPC H01F 41/0206; H01F 27/24; H02K 15/027; H02K 15/0273

(57) ABSTRACT

A method punches and holds an iron core piece from a magnetic steel plate into a die using a punch, rotates the die at a predetermined angle, repeats the holding for an iron core piece based on the punching and the rotating of the die to form laminated iron cores in which iron core pieces are laminated, and separates the laminated iron core with a predetermined height being lower and coming off the die to be supported on a receiving stage from the laminated iron core being upper according to descending of the receiving stage, wherein the rotating of the die is stopped at the time of the descending of the receiving stage in a state that the laminated iron core being lower is come off the die.

### FIELD OF THE INVENTION

The present invention relates to a manufacturing method, a manufacturing device and a laminated iron core of a core for an electric motor or a generator.

### BACKGROUND OF THE INVENTION

As a conventional manufacturing method of a core, there is a manufacturing method of a laminated iron core disclosed in Patent document 1, for example.

The manufacturing method punches and holds an iron core piece from a magnetic steel plate using a punch into a die and rotates the die at a predetermined angle. Then, it repeats the holding of an iron core piece based on the punching and the rotating of the die, thereby forming a laminated iron core in which a plurality of the iron core pieces are laminated while shifting their phases, i.e., a plurality of the iron core pieces are rotationally laminated.

The formed laminated iron core is received on a receiving stage and is ejected by descending the receiving stage when coming off the die.

The manufacturing method improves manufacturing efficiency according to raising in punching velocity for the iron core pieces and rotational velocity of the die. Raising the punching velocity for the iron core pieces and the rotational velocity of the die, the die may be, however, started to be rotated before the laminated iron core coming off the die is left from an upper laminated iron core held in the die.

As this result, end faces of the lower and the upper laminated iron cores are slid on each other and there is a risk to scratch the laminated iron cores.

### PATENT LITERATURE 1: JPS 60-92023A

### SUMMARY OF THE INVENTION

A problem to be solved is that there is a risk to scratch laminated iron cores according to sliding of end faces thereof.

The present invention provides a manufacturing method of a core comprising punching and holding an iron core piece from a magnetic steel plate into a die using a punch, rotating the die at a predetermined angle, repeating the punching and holding step and the rotating step to form laminated iron cores in which iron core pieces are laminated, and separating the laminated iron core with a predetermined height being lower and coming off the die to be supported on a receiving stage from the laminated iron core being upper according to descending of the receiving stage, wherein the rotating of the die is stopped at the time of the descending of the receiving stage in a state that the laminated iron core being lower is come off the die.

The present invention provides a manufacturing device of a core comprising a punch for punching and a rotatable die, a receiving stage being liftable, and a controller to control the punch, the die and the receiving stage, wherein the controller conducts holding an iron core piece punched from a magnetic steel plate using the punch into the die, rotating the die at a predetermined angle, repeating the holding of an iron core piece based on the punching and the rotating of the die to form laminated iron cores in which iron core pieces are laminated, and separating the laminated iron core with a predetermined height being lower and coming off the die to be supported on a receiving stage from the laminated iron core being upper according to descending of the receiving stage, wherein the rotating of the die is stopped at the time of the descending of the receiving stage in a state that the laminated iron core being lower is come off the die.

According to the present invention, end faces of the laminated iron cores being lower and upper are not slid on each other and it prevents the laminated iron cores being lower and upper from being scratched.

### BRIEF DESCRIPTION OF THE DRAWINGS

FIG. 1 is a schematic sectional view illustrating a manufacturing device for a core according to an embodiment of the present invention;

FIG. 2 is a schematic sectional view illustrating a part of FIG. 1 with enlargement;

FIGS. 3A-FIG. 3D are schematic sectional views illustrating a manufacturing method of a core according to the embodiment; and

FIG. 4A and B are conceptual views illustrating laminated iron cores according to the embodiment.

### EMBODIMENT FOR CARRYING OUT THE INVENTION

The object of preventing scratches caused by sliding end faces of laminated iron cores on each other is achieved by temporarily stopping rotating of a die.

Namely, a manufacturing method of a core of the present invention punches and holds an iron core piece P from a magnetic steel plate W into a die 5 using a punch 3 and rotates the die 5 at a predetermined angle. The holding of an iron core piece P based on the punching and the rotating of the die 5 are repeated to form laminated iron cores S in which iron core pieces P are laminated. Then, the laminated iron core S with a predetermined height being lower and coming off the die 5 to be supported on a receiving stage 7 is separated from the laminated iron core S being upper according to descending of the receiving stage 7. The rotating of the die 5 is stopped at the time of the descending of the receiving stage 7 in a state that the laminated iron core S being lower is come off the die 5.

Although the stopping of the rotating of the die 5 should be performed at least when the laminated iron core S being lower is separated from the laminated iron core S being upper, it may be performed over a period before and after the laminated iron core S being lower is come off the die 5.

Further, the stopping of the rotating of the die 5 may be performed over a period before and after the receiving stage 7 is descended or a period from when the laminated iron core S being lower is come off the die 5 to when the receiving stage 7 is descended.

Further, the stopping of the rotating of the die 5 may be performed from when the receiving stage 7 is descended to when the receiving stage is ascended to a supporting position for the laminated iron core S being upper after the laminated iron core S being lower is ejected from the receiving stage 7.

The iron core pieces P laminated during the stopping of the rotating of the die 5 may be 5-20% of the laminated iron core S with the predetermined height, although it varies in rate relative to the laminated iron core S according to the stopping of the die 5 or a laminating height of the laminated iron core S.

A manufacturing device 1 of a core is provided with the punch 3 for punching and the rotatable die 5, the receiving stage 7 being liftable, a controller 9 to control the punch 3, the die 5 and the receiving stage 7.

The controller 9 conducts holding an iron core piece P punched from the magnetic steel plate W using the punch 3 into the die 5, rotating the die 5 at a predetermined angle, repeating the holding of an iron core piece P based on the punching and the rotating of the die 5 to form laminated iron cores S in which iron core pieces P are laminated. Further, the controller 9 performs separating the laminated iron core S with a predetermined height being lower and coming off the die 5 to be supported on the receiving stage 7 from the laminated iron core S being upper according to descending of the receiving stage 7. The controller 9 stops the die 5 being rotated at the time of the descending of the receiving stage 7 in a state that the laminated iron core S being lower is come off the die 5.

In the laminated iron core S manufactured by the manufacturing method of a core, the iron core pieces P punched during the stopping of the rotating of the die 5 are located on both sides or on an intermediate portion in the laminating direction.

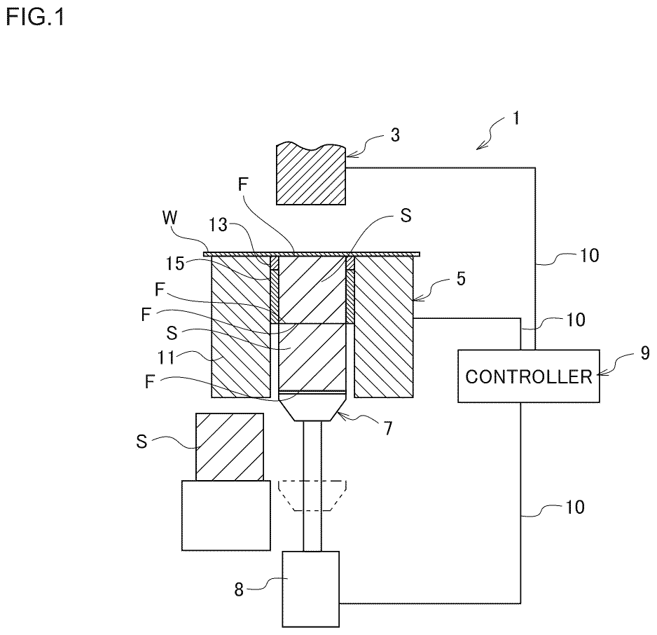

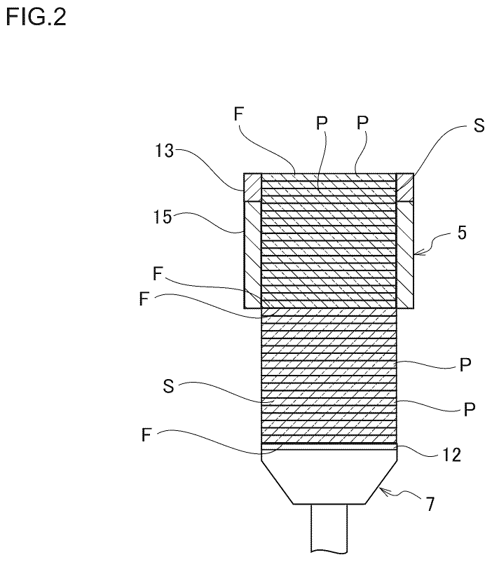

FIG. 1 is a schematic sectional view illustrating a manufacturing device for a core according to the embodiment 1 of the present invention. FIG. 2 is a schematic sectional view illustrating a part of FIG. 1 with enlargement.

A manufacturing device 1 of a core is used for a manufacturing method of a core such as a rotor core or a stater core for an electric motor or a generator and is, for example, incorporated in a manufacturing line. The manufacturing device 1 sequentially punches a plurality of iron core pieces P out from a magnetic steel plate W intermittently supplied, thereby forming a laminated iron core S for a core in which a plurality of the iron core pieces are laminated while shifting their phases, i.e., a plurality of the iron core pieces P are rotationally laminated. In addition, each iron core piece P is a single annular iron core piece.

The manufacturing device 1 is provided with a punch 3 and a die 5, a receiving stage 7, and a controller 9.

The punch 3 is provided with an upper mold (not illustrated) and is configured to be descended and ascended. The die 5 is provided with a lower mold (not illustrated) and is arranged so as to correspond to the punch 3. The punch 3 and the die 5 sequentially punch out and hold a plurality of the icon core pieces P from the magnetic steel plate W into the die 5, the magnetic steel plate intermittently supplied between the upper mold and the lower mold.

The die 5 is configured to be rotatable and is intermittently rotated at a predetermined angle in one direction. The angle (predetermined angle) for one rotation of the die 5 is optionally and may be set to 30 degrees, 60 degrees, 90 degrees, 120 degrees, 180 degrees or the like. The rotating of the die 5 is realized by an appropriate drive device such as a servo motor and is performed every punching of the single iron core piece P.

The die 5 of the present embodiment is provided with a die holder 11, a die body portion 13, and a squeeze ring 15. The die holder 11 is formed into a cylindrical shape and is rotatably supported with the lower mold by means of bearings (not illustrated).

To the die holder 11, the die body portion 13 and the squeeze ring 15 are supported. The die body portion 13 is formed into a ring shape and is fixed on an inner periphery of a support hole 11a of the die holder 11. In addition, the die body portion 13 may be rotatably and directly supported on the lower mold together with the squeeze ring 15 with omission of the die holder 11.

The squeeze ring 15 is arranged adjacent to the die body portion 13 in a punching direction for the iron core pieces P and is supported on the inner periphery of the support hole 11a. The squeeze ring 15 is formed into a ring shape longer than the die body portion 13 in the punching direction. In addition, the punching direction is identical with the laminating direction of the iron core pieces P.

The squeeze ring 15 holds the punched iron core piece P by applying lateral pressure according to pressing from an outer periphery. A plurality of the iron core pieces P held in the squeeze ring 15 are laminated on each other, whereby the laminated iron core S is formed. In addition, although only the single laminated iron core S is positioned in the squeeze ring 15 in the present embodiment, a plurality of the laminated iron cores S may be positioned in the squeeze ring 15.

In addition, the die 5 may omit the squeeze ring 15. In this case, the die body portion 13 should be elongated in the punching direction or the support hole 11a of the die holder 11 should be reduced in diameter to hold the punched iron core piece P.

The receiving stand 7 is configured to be liftable relative to the die 5 and supports the laminated iron core S by putting the laminated iron core thereon. The receiving stage 7 is provided with a rotary plate 12 that rotates together with the put laminated iron core S. In addition, the rotary plate 12 may be omitted.

Ascending and descending of the receiving stage 7 are performed by an appropriate lifting device such as a hydraulic cylinder. The receiving stage 7 descends together with the laminated iron core S in a putting-on state while contacting and receiving an end face F of the laminated iron core S descending in the squeeze ring 15 according to the laminating of the iron core pieces P. This descending is descending for the laminating of the iron core pieces P and the receiving stage 7 descends by thicknesses of the iron core pieces P that are laminated.

The receiving stage 7 allows the laminating iron core S reaching the predetermined height and coming off the die 5 to be separated from the laminated iron core S being upper according to descending of the receiving stage. This descending is descending for the separating of the laminated iron cores S and has a descending amount larger than of the descending for the laminating of the iron core pieces P. The coming-off of the laminated iron core 5 from the die 5 is to release the laminated iron core S from a holding state with the die 5 and, in the present embodiment, to release the laminated iron core from the lateral pressure by coming off the die 5.

The descended receiving stage 7 leads the laminated iron core S put thereon to be ejected at a predetermined ejecting position. The ejecting may be performed by an appropriate ejecting device such as a pusher. The receiving stage 7 after the ejecting is ascended up to a supporting position for the laminated iron core S being upper.

The supporting position is a position at which the receiving stage 7 is brought into contact with the end face F of the laminated iron core S being upper. It should be noted that the supporting position may be a predetermined position regardless of the position of the end face F of the laminated iron core S being upper.

The controller 9 is an information processing device having a processor and a memory and controls the punch 3, the die 5, and the receiving stage 7. The controller 9 is connected to the drive parts of the punch 3 and the die 5 and a lifting device 8 of the receiving stage 7 through appropriate data lines 10.

The data lines 10 are, however, indicated as directly connected to the punch 3 and the die 5 in FIG. 1. In addition, the controller 9 may be not only the single information processing device but also a combination of a plurality of information processing devices.

The controller 9 makes an iron core piece P punched from the magnetic steel plate W be held into the die 5 according to control of the punch 3 and the die 5 and rotates the die 3 at the predetermined angle. Then, the controller 9 repeats the holding of an iron core piece P based on the punching and the rotating of the die 5, thereby forming the laminated iron core S in which a plurality of the iron core pieces P are laminated while shifting their phases.

Further, the controller 9, on the basis of control of the receiving stage 7, makes the laminated iron core S with the predetermined height being lower and coming off the die 5 to be supported on the receiving stage 7 separate from the laminated iron core S being upper according to the descending of the receiving stage 7. Timing of the descending is when the number of the punching of the iron core pieces P is reached to a predetermined number. The predetermined number corresponds to time when or after the laminated iron core S being lower comes off the die 5.

Further, the controller 9 of the present embodiment, on the basis of the control of the punch 3 and the die 5, stops the rotating of the die 5 when the receiving stage 7 is descended after the laminated iron core S being lower is come off the die 5. During even the stopping, it continues holding iron core pieces P into the die 5 according to the punching of the punch 3.

The stopping of the rotating of the die 5 should be performed at least when the laminated iron core S being lower is separated from the laminated iron core S being upper. According to the present embodiment, the stopping of the rotating of the die 5 is performed over a period before and after the laminated iron core S being lower is come off the die 5.

Time before the laminated iron core S being lower is come off the die 5 is a state that an upper end portion of the laminated iron core S is expected to be held on the die 5, and time after the laminated iron core S being lower is come off the die 5 is a state that the upper end portion of the laminated iron core S is expected not to be held on the die 5.

This expecting uses the laminated iron core S having a height as designed (designed height) as a standard. An expected height may be, however, used as a standard, the expected height being the designed height of the lower laminated iron core S in view of variation at the time of manufacturing. In this case, time before the laminated iron core S being lower is come off the die 5 should be when or before the upper end portion of the laminated iron core S being lower having a lowest expected height is come off the die 5.

Similarly, time after the laminated iron core S being lower is come off the die 5, in a case of using the expected height of the laminated iron core S being lower should be when or after the upper end portion of the laminated iron core S being lower having a highest expected height is come off the die 5.

In particular, a period before and after the laminated iron core S being lower is come off the die 5 is a range that a distance (descending amount during the stopping) between positions of the end face F of the upper end of the laminated iron core S before and after the coming-off in the laminating direction is 5-20% of the laminated iron core S.

The stopping of the rotating of the die 5 after the laminated iron core S being lower is come off the die 5 is performed until the receiving stage 7 is ascended up to the supporting position for the laminated iron core S being upper after the receiving stage is descended and the laminated iron core S being lower is ejected from the receiving stage 7.

The stopping of the rotating of the die 5 is, therefore, performed over a period before and after the receiving stage 7 is descended. It should be noted that the stopping of the rotating of the die 5 may be performed over only the period before and after the receiving stage 7 is descended. In this case, time before the receiving stage 7 is descended may be time before, when, or after the laminated iron core S being lower is come off the die 5, or time therebefore or thereafter.

According to the present embodiment, it takes about 2 seconds until the receiving stage 7 returns to the support position after descending. In this case, stopping time of the rotating of the die 5 may be shortened if time required for ejecting operation is shortened by making the ejecting position closer to the die 5 or the like.

Further, the stopping of the die 5 should be performed at least only a moment when the laminated iron core S being lower is separated from the laminated iron core S being upper and may be shorter time.

The iron core pieces P laminated during the stopping of the rotating of the die 5 (referred to as un-rotated iron core pieces P in some cases) are 5-20%, preferably 5-10%, of the laminated iron core S of the predetermined height.

In this way, the stopping of the rotating of the die 5 is performed over the period before and after the laminated iron core S being lower is come off inclusive of a period from when the laminated iron core S being lower is come off the die 5 to when the receiving stage 7 is descended. It should be noted that the stopping of the rotating of the die 5 may be performed over only the period from when the laminated iron core S being lower is come off the die 5 to when the receiving stage 7 is descended.

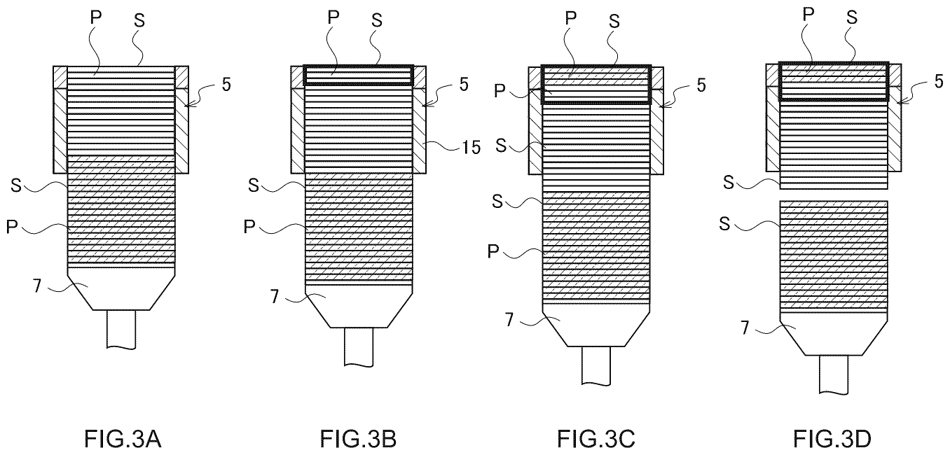

FIGS. 3A-D are schematic sectional views illustrating the manufacturing method of a core according to the embodiment 1. In addition, hatching of the laminated iron core S being upper is omitted in FIGS. 3A-D so as to be easily understood. Further, in the following explanation based on FIGS. 3A-D, an example of the iron core pieces S having a designed height will be explained.

The manufacturing method of a core according to the present embodiment intermittently supplies the magnetic steel plate W between the upper mold and the lower mold, namely repeats supplying and stopping, and the iron core piece P is punched from the magnetic steel plate W into the die 5 using the punch 3 to be held at every stopping as illustrated in FIG. 1 and FIG. 3 first.

The punched iron core pieces P are sequentially laminated on the receiving stage 7 while the lateral pressure is applied to the punched iron core pieces by means of the squeeze ring 15 after passing the die body portion 13. The receiving stage 7 is descended according to the laminating of the iron core pieces P to allow the iron core pieces P to be sequentially laminated.

When punching each iron core piece P, the die 5 is rotated at the predetermined angle in a circumferential direction of the iron core piece P before and after the punching. With this, the iron core piece P held into the die 5 is laminated with respect to the iron core piece P punched just before while shifting its phase.

A plurality of the laminated iron core pieces P in a state of connected to each other through fastening forms the laminated iron core S. The fastening is performed when the iron core piece P punched by the punch 3 is laminated.

The laminating is finished at a time when the laminated iron core S reaches the predetermined height. This laminated iron core S with the predetermined height is lower and the laminating for the laminated iron core S to be upper is successively started thereon. Between the laminated iron cores S being lower and upper, they only contact each other with no connection by means of fastening.

Advancing the laminating for the laminated iron core S being upper, the laminated iron core S being lower is come off the die 5 so as to be pushed out by the laminated iron core S being upper. The laminated iron core S being lower and being come off the die 5 is in a rotatable state relative to the laminated iron core S being upper and being held by the die 5.

According to the present embodiment, as illustrated in FIG. 3, the rotating of the die 5 is stopped over the period before and after the laminated iron core S being lower is come off the die 5 and the laminating of the iron core pieces P is continued for the laminated iron core S being upper. In addition, in FIG. 3, the iron core pieces P laminated during the stopping of the rotating of the die 5 are indicated by being surrounded with thick lines.

During the stopping of the rotating of the die 5, the laminated iron core S being lower and being come off the die 5 is separated from the laminated iron core S being upper according to the descending the receiving stage 7. Namely, the laminated iron core S being lower and coming off the die 5 is separated from the laminated iron core S being upper while the relative rotation of the laminated iron core S being upper is prevented by the stopping of the rotating of the die 5.

In particular, as illustrated in FIG. 3A, the stopping of the rotating of the die 5 is started before the laminated iron core S being lower is come off the die 5. At this time, the laminated iron core S being lower is reduced in holding force caused by the die 5 by comparison with the weight. With this, the laminated iron core S being lower may not be rotated along with the die 5 rotating and may be rotated relatively to the laminated iron core S being upper.

In contrast, the present embodiment stops the rotating of the die 5 before the laminated iron core S being lower is come off the die 5, thereby preventing relative rotation between the laminated iron core S being lower and the laminated iron core S being upper to suppress scratches thereof.

In the state of the stopping state of the rotating of the die 5, it continues the punching and the holding of the iron core pieces P so that a laminating height of the laminated iron core S being upper becomes higher, and the laminated iron core S being lower is descended accordingly.

Then, as illustrated in FIG. 3B, the laminated iron core S being lower is come off the die 5 when the end face F on the upper end of the laminated iron core S being lower is positioned below an opening of the squeeze ring 15. In addition, the coming-off of the laminated iron core S being lower from the die 5 is not detected.

Next, as illustrated in FIG. 3C and FIG. 3D, when the laminated iron core S being lower is further descended and the number of the punching of the iron core pieces P reaches the predetermined number counting from the previously descending, the receiving stage 7 is descended. With this descending, the laminated iron core S being lower is separated from the laminated iron core S being upper.

At this time, the present embodiment starts the laminating of the iron core pieces P for the laminated iron core S being further upper with respect to the laminated iron core S being upper. In addition, the iron core pieces P of the laminated iron core S being further upper are indicated with hatching in FIG. 3C and FIG. 3D.

In this way, the present embodiment separates the laminated iron core S being lower and being come off the die 5 from the laminated iron core S being upper while the relative rotation to the laminated iron core S being upper is prevented by the stopping of the rotating of the die 5.

Even if punching velocity for the iron core piece P and rotational velocity of the die 5 are raised to improve manufacturing efficiency, the end faces F of the laminated iron cores S being lower and upper are, therefore, not slid on each other and these laminated iron cores S are prevented from being scratched.

Further, since the present embodiment stops the rotating of the die 5 over a period before and after the laminated iron core S being lower is come off the die 5, it adapts to variation in height of the laminated iron core S being lower even if the coming-off of the laminated iron core S being lower from the die 5 is not detected.

In particular, the un-rotated iron core pieces P is set between 5-20%, so that it surely adapts to variation in height of the laminated iron core S while suppressing the un-rotated iron core pieces P from affecting on the laminated iron core S.

After the receiving stage 7 is descended, the receiving stage 7 is positioned at the ejecting position and the laminated iron core S being lower is ejected from the receiving stage 7. After that, the receiving stage 7 is ascended to the supporting position for the laminated iron core S being upper to be brought into contact with the end face F of the laminated iron core S being upper. The stopping of the rotating of the die 5 is continued until the receiving stage 7 reaches the supporting position. It, therefore, suppresses relative rotation between the receiving stage 7 and the laminated iron core S to suppress the laminated iron core S from being scratched.

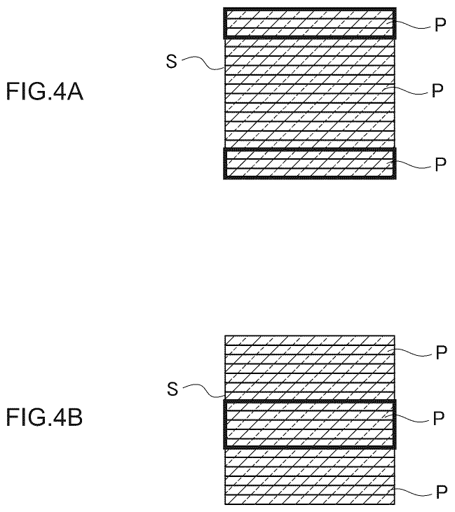

FIG. 4A and B are conceptual views illustrating laminated iron cores S.

As illustrated in FIG. 4A and B, positions of un-rotated iron core pieces P are varied in the laminated iron core S according to timing of the stopping of the rotating of the die 5, the finishing of the laminated iron core S and the like.

If the iron core S is finished while the rotating of the die 5 is stopped, the un-rotated iron core pieces P are positioned on both sides of the laminated iron core S in the laminating direction. In this case, since the un-rotated iron core pieces P are arranged so as to be distributed to both sides in the laminating direction, accuracy of the laminated iron core S including the un-rotated iron core pieces P is improved.

If the laminated iron core S is not finished while the rotating of the die 5 is stopped, the un-rotated iron core pieces P are positioned on an intermediate portion of the laminated iron core S in the laminating direction. In this case, the un-rotated iron core pieces P are positioned in the intermediate portion in the laminating direction, thereby being superior in balance while including the un-rotated iron core pieces P.

1. A manufacturing method of a core comprising:
punching and holding an iron core piece from a magnetic steel plate into a die using a punch;
rotating the die at a predetermined angle;
repeating the punching and holding step and the rotating step to form laminated iron cores in which iron core pieces are laminated; and
separating the laminated iron core with a predetermined height being lower and coming off the die to be supported on a receiving stage from the laminated iron core being upper according to descending of the receiving stage, wherein
the rotating of the die is stopped at the time of the descending of the receiving stage in a state that the laminated iron core being lower is come off the die.

2. The manufacturing method of a core according to claim 1, wherein
the stopping of the rotating of the die is performed over a period before and after the laminated iron core being lower is come off the die.

3. The manufacturing method of a core according to claim 1, wherein
the stopping of the rotating of the die is performed over a period before and after the receiving stage is descended.

4. The manufacturing method of a core according to claim 1, wherein
the stopping of the rotating of the die is performed over a period from when the laminated iron core being lower is come off the die to when the receiving stage is descended.

5. The manufacturing method of a core according to claim 1, wherein
the stopping of the rotating of the die is performed from when the receiving stage is descended to when the receiving stage is ascended to a supporting position for the laminated iron core being upper after the laminated iron core being lower is ejected.

6. The manufacturing method of a core according to claim 1, wherein
the iron core pieces laminated during the stopping of the rotating of the die are 5-20% of the laminated iron core with the predetermined height.

7. A manufacturing device of a core comprising:
a punch for punching and a rotatable die;
a receiving stage being liftable; and
a controller to control the punch, the die and the receiving stage, wherein
the controller conducts
holding an iron core piece punched from a magnetic steel plate using the punch into the die;
rotating the die at a predetermined angle;
repeating the holding of an iron core piece based on the punching and the rotating of the die to form laminated iron cores in which iron core pieces are laminated; and
separating the laminated iron core with a predetermined height being lower and coming off the die to be supported on a receiving stage from the laminated iron core being upper according to descending of the receiving stage, wherein
the rotating of the die is stopped at the time of the descending of the receiving stage in a state that the laminated iron core being lower is come off the die.

8. A laminated iron core manufactured by the manufacturing method of a core according to claim 1, comprising:
the plurality of the iron core pieces laminated together, the laminated iron core pieces including rotated iron core pieces and un-rotated iron core pieces, the rotated iron core pieces each circumferentially rotated at the predetermined angle relatively to a lower iron core piece in the laminating direction, and the un-rotated iron core pieces each circumferentially un-rotated relatively to a lower iron core piece in the laminating direction, wherein
the un-rotated iron core pieces are located on both sides in a laminating direction.

9. A laminated iron core manufactured by the manufacturing method of a core according to claim 1, comprising:
the plurality of the iron core pieces laminated together, the laminated iron core pieces including rotated iron core pieces and un-rotated iron core pieces, the rotated iron core pieces each circumferentially rotated at the predetermined angle relatively to a lower iron core piece in the laminating direction, and the un-rotated iron core pieces each circumferentially un-rotated relatively to a lower iron core piece in the laminating direction, wherein
the un-rotated iron core pieces are located on an intermediate portion in a laminating direction.
